(19) United States
(12) Patent Application Publication
(10) Pub. No.: US 2009/0299888 A1
(43) Pub. Date: Dec. 3, 2009

(54) Testing a quality of a report

(75) Inventor: Frederick William Stoll, JR., Hoboken, NJ (US)

Correspondence Address: Paul D. Greeley;Ohlandt, Greeley, Ruggiero & Perle, L.L.P., 10th Floor, One Landmark Square, Stamford, CT, 06901-2682, US

(73) Assignee: DUN & BRADSTREET, INC.,

(21) Appl. No.: 12/386,487

(22) Filed: Apr. 17, 2009

Related U.S. Application Data
(60) Provisional application No. 61/124,720, filed on Apr. 18, 2008.

(51) Int. Cl. G06Q 40/00

(52) U.S. Cl. 705/35

(57) ABSTRACT

There is provided a method that includes receiving a request to provide a report; determining whether content of the report meets a threshold level of quality; and issuing a warning if the content does not meet the threshold level of quality.

### CROSS-REFERENCE TO RELATED APPLICATIONS

The present application is claiming priority to U.S. Provisional Patent Application No. 61/124,720, filed Apr. 18, 2008, the content of which is herein incorporated by reference.

### BACKGROUND OF THE INVENTION

1. Field of the Invention

The present disclosure relates to a determination as to whether a report meets a certain level of quality, and more particularly, to a determination of whether a credit report concerning a business entity meets a certain level of quality.

2. Description of the Related Art

A business, in deciding whether to enter a relationship with another entity, frequently includes in a decision process, an assessment of risks relating to the entity. Included among the risks is the creditworthiness of the entity.

It is commonplace for a business to obtain creditworthiness data from a third-party vendor that specializes in credit reporting. Commonly this is effectuated by the business, purchasing from the vendor, a credit report pertaining to the entity of interest.

A shortcoming of this approach is the lack of quality-checking of a credit report made available by vendors in response to the business's request for the credit report. Credit reports often suffer the deficiency of silently omitting a known relationship between the entity of interest and a parent entity. Credit reports further suffer from the deficiency of not taking into account the recency of reportable activities, credit rating scores, and other metrics. The present disclosure provides a method of implementing quality-checking for credit reports that mitigates these and other deficiencies.

### SUMMARY OF THE INVENTION

There is provided a method that includes receiving a request to provide a report; determining whether content of the report meets a threshold level of quality; and issuing a warning if the content does not meet the threshold level of quality.

### BRIEF DESCRIPTION OF THE DRAWINGS

A component or a feature that is common to more than one drawing is indicated with the same reference number in each of the drawings, in which:

FIG. 1 is a block diagram of a method for accessing a credit report.

FIG. 2 is a block diagram of a subroutine of the method of FIG. 1.

FIG. 3 is a block diagram of a system configured for execution of the method of FIGS. 1 and 2.

### DESCRIPTION OF THE INVENTION

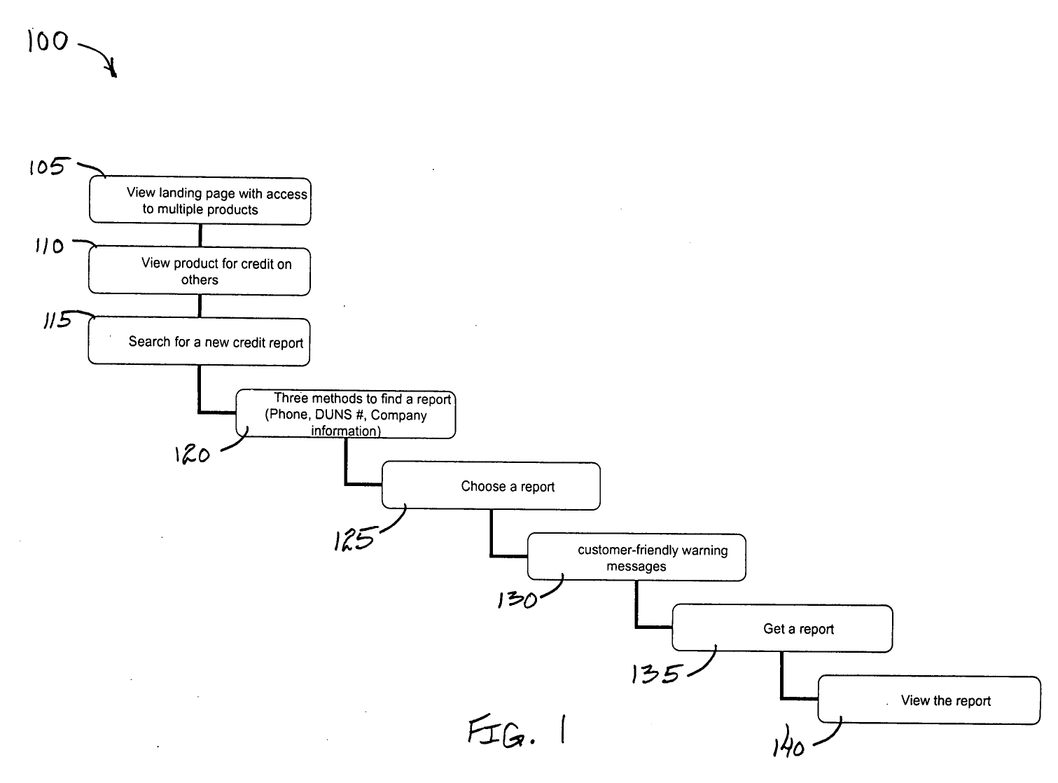

FIG. 1 is a block diagram of a method 100 for accessing a credit report. Method 100 begins at step 105.

In step 105, a user views a landing page with access to multiple products. The landing page is a home page accessed by users, via a communication network such as the Internet, for high-level information. The landing page can serve as a launch site for multiple products that are tailored to various types of users, e.g. a small business. Among other functions, the landing site can implement the function of receiving the user's requests for reports, information, and other products. Method 100 next proceeds to step 110.

In step 110, the user views a product for reporting credit on an entity. The product provides the user with information regarding a credit status of an entity or entities in which the user may be interested. Method 100 next proceeds to step 115.

In step 115, the user searches for a new credit report. That is, the user generates a request that a report be provided by method 100. The user is provided a portal, e.g. a webpage, from which the user may begin a search for new credit reports on an entity. The customer is granted the ability to access a predetermined number of such reports. Method 100 next proceeds to step 120.

In step 120 a user is presented with a plurality of methods to access (i.e., search for) a report relating to an entity of interest. The plurality of methods can include, by way of non-limiting example, referencing a report of interest according to the entity's telephone number, or company information. Method 100 next proceeds to step 125.

In step 125, the user is presented with a list comprising results of a search performed according to the methods of access of step 120. From the list, the user is able to select a report of interest (i.e., a “selected report”) for possible subsequent delivery to the user. Method 100 next proceeds to step 130.

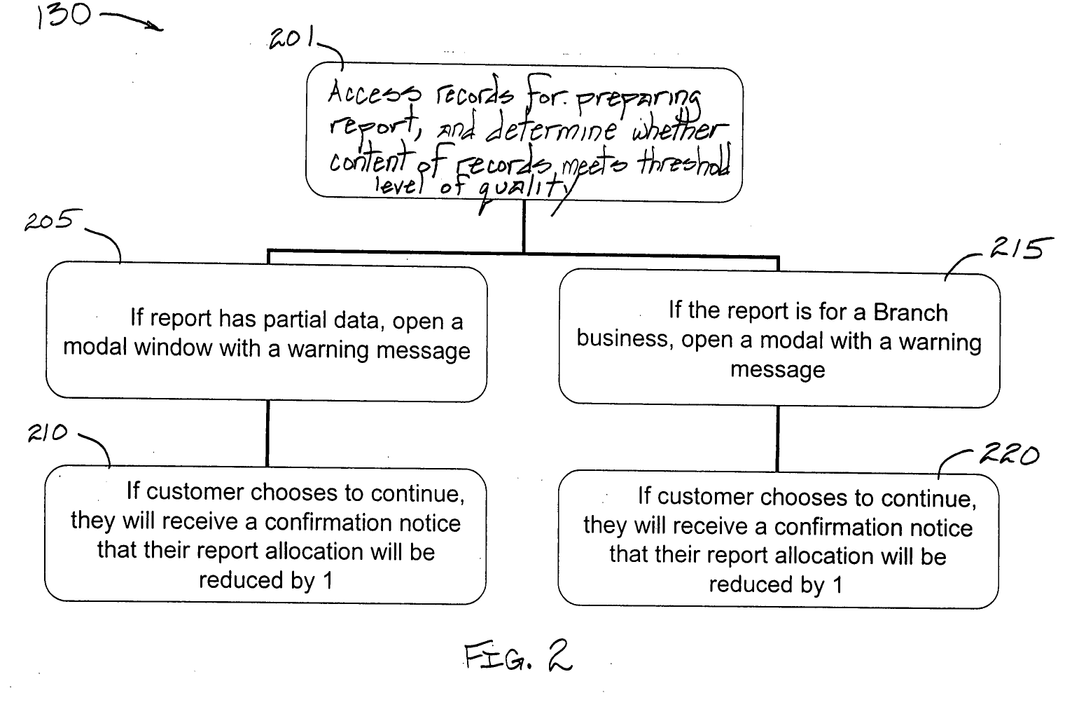

In step 130, the user is optionally presented with a customer-friendly warning message. The customer-friendly warning message may be presented if, for example, the selected report (see step 125) pertains to a first entity that is a subsidiary of, or controlled by, a second entity. That is, the second entity, e.g., a parent company, might ultimately be responsible for credit. In such a case, the user would be presented with a customer-friendly warning message that indicates that a report on the second entity might be more relevant (a “suggested report”) to the user's interests. The customer-friendly warning message may also be presented if, for example, the selected report is deemed to be incomplete (e.g., missing a credit rating score pertaining to the entity of interest, or missing a standard industrial classification (SIC) of the entity of interest). Additionally, the warning message may be presented if the report is deemed to be outdated, such as when the report does not show any trade experiences for the entity in a predetermined period of time, e.g. 18 months. Further details of step 130 are described below, in association with FIG. 2. Method 100 next proceeds to step 135.

In step 135, the user, if still desirous of purchasing the report, initiates a communication that indicates the user's intent to purchase the selected report or the suggested report. If the user has subscribed to receive a predetermined number of reports, the allotted predetermined number of reports is decremented. If the user's allotted predetermined number of reports is below a predetermined threshold, the user's purchase will fail, pending an increment of the user's allotted predetermined number of reports. If the purchase is made, the report is dispatched to the user. Method 100 next proceeds to step 140.

In step 140, the user accesses the purchased report, which has features tailored to attributes of the user, e.g., small business status of the user.

FIG. 2 is a block diagram of step 130, i.e., presentation of a customer-friendly warning message, referred to below as method 130. Method 130 is entered at step 201.

In step 201, records are accessed for preparing a report, and a determination is made as to whether the content of the records meets a threshold level of quality. Quality could pertain to completeness of the records, whether the records were updated within a predetermined period of time prior to a present time, the pertinence of the records to an entity that is a subordinate entity to another entity, or a combination of these. If the report has partial data, i.e., if the report is below a completeness quality threshold, then method 130 proceeds to step 205. If the report is pertaining to an entity that is a branch business, then method 130 proceeds to step 215.

In step 205, a modal window is opened, having a warning message appropriate to the case where a report has partial data. If the user wishes to continue, i.e., receive the report even though it may be incomplete, and so indicates by a communication with the modal window to confirm that the request for the report should be fulfilled, then method 130 next proceeds to step 210. If the user does not wish to continue, method 130 ends.

In step 210, the user receives a confirmation notice. If the user has subscribed to receive a predetermined number of reports, the confirmation notice informs the user that the user's allotted predetermined number of reports has been decremented. Upon completion of step 210, method 130 returns to the routine from which it was called.

In step 215, a modal window is opened, having a warning message appropriate to the case where a report pertains to an entity that is a branch entity. A branch entity is an entity that is, for example, a subsidiary of an entity, rather than a parent entity in its own right or a single standalone office. If the user wishes to continue, i.e., receive the report even though it pertains to a subsidiary entity, then the user issues a communication to confirm that the request for the report should be fulfilled, then method 130 next proceeds to step 220. If the user does not wish to continue, method 130 then ends.

In step 220, the user receives a confirmation notice. If the user has subscribed to receive a predetermined number of reports, the confirmation notice informs the user that the user's allotted predetermined number of reports has been decremented. Upon completion of step 220, method 130 returns to the routine from which it was called.

Steps associated with the method of FIGS. 1 and 2 can be performed in any order, unless otherwise specified or dictated by the steps themselves. Also, although FIG. 2 represents steps 205 and 215 as if only one of them is performed, both of steps 205 and 215 could be performed so that the warning message could indicate a situation where a report is both incomplete (i.e., step 205) and pertains to a subsidiary rather than a parent (i.e., step 215).

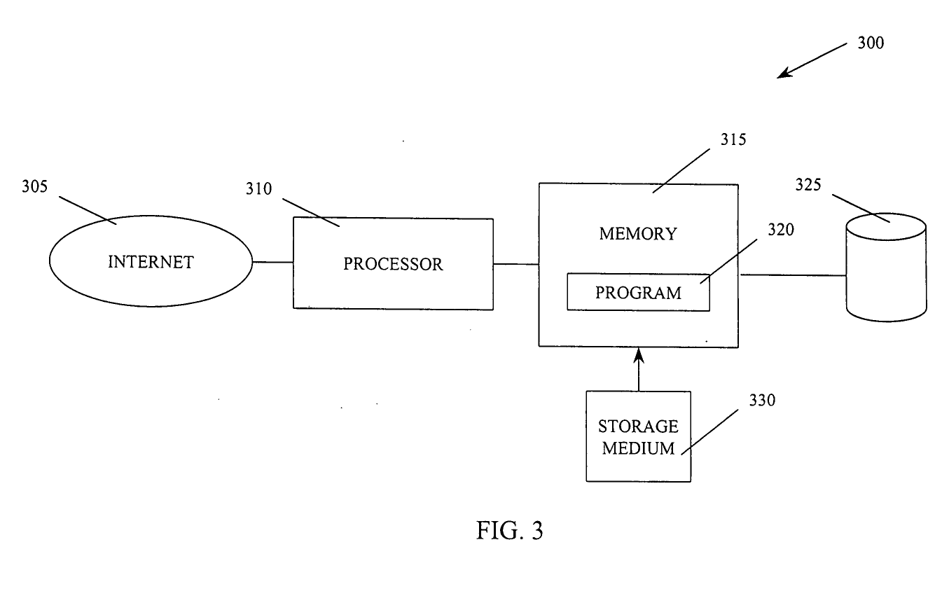

FIG. 3 is a block diagram of a system 300 configured for execution of the method of FIGS. 1 and 2. System 300 includes a processor 310, a memory 315, and a data store 325.

Processor 310, for example a general-purpose processor, is in communication with a communication network 305, such as the Internet. Processor 310 is also in communication with memory 315.

Memory 315 provides storage for a software module such as program 320. Memory 315 is any suitable memory known in the art. Program 320 is configured as one or more modules, and embodies instructions that, when executed by processor 310, cause processor 310 to perform the methods of FIGS. 1 and 2. The term “module” is used herein to denote a functional operation that may be embodied either as a stand-alone component or as an integrated configuration of a plurality of subordinate components. Memory 315 is further in communication with data store 325.

Data store 325 contains data about the entity for which the user is requesting the credit report. It is this data, and more specifically the quality of this data, that is being considered by the methods of FIGS. 1 and 2. Data store 325 can be any suitable repository for data storage, including flat files, databases, and various storage media.

Although system 300 is described herein as having program 320 installed into memory 315, program 320 can be tangibly embodied on an external computer-readable storage medium 330 for subsequent loading into memory 315. Storage medium 330 can be any conventional storage medium, including, but not limited to, a floppy disk, a compact disk, a magnetic tape, a read only memory, or an optical storage media. The instructions could also be embodied in a random access memory, or other type of electronic storage, located on a remote storage system that is coupled to memory 315.

Moreover, although program 320 is described herein as being installed in memory 315, and therefore being implemented in software, program 320 could be implemented in any of hardware, firmware, software, or a combination thereof.

A user accesses and communicates with system 300 via a user interface (not shown) that is also coupled to communication network 305. Operation of system 300 commences with instantiation of a communication with a user, via communication network 305. Processor 315, in response to the communication, executes instructions of program 320. As required, data pertaining to the handling and fulfillment of a request embedded in the communication are read from and written to data store 325. In turn, processor 310 instantiates a responsive communication with the user according to predetermined requirements of program 320.

Thus, system 300, via communication network 305, receives a request from a user via a user interface, to provide a report. System 300 determines whether content of the report meets a threshold level of quality, and issues a warning to the user via the user interface, if the content does not meet the threshold level of quality. If the user, in spite of the warning, still wishes to receive the report, the user sends a communication that confirms that the request should be fulfilled. System 300, receives the communication, and in response to the communication, dispatches the report to the user interface, via communication network 305.

The techniques described herein are exemplary, and should not be construed as implying any particular limitation on the present invention. It should be understood that various alternatives, combinations and modifications could be devised by those skilled in the art. The present invention is intended to embrace all such alternatives, modifications and variances that fall within the scope of the appended claims.

What is claimed is:

1. A method comprising:
receiving a request to provide a report;
determining whether content of said report meets a threshold level of quality; and
issuing a warning if said content does not meet said threshold level of quality.

2. The method of claim 1, further comprising:
receiving a communication that confirms that said request should be fulfilled; and
dispatching said report, in response to said communication.

3. The method of claim 1, wherein said quality is indicative of whether said content is complete.

4. The method of claim 1, wherein said quality is indicative of whether said content has been updated within a predetermined period prior to a present time.

5. The method of claim 1, wherein said quality is indicative of whether said report concerns an entity that is subordinate to another entity.

6. The method of claim 1, further comprising:
receiving a communication that confirms that said request should be fulfilled; and
dispatching said report, in response to said communication,
wherein said quality is indicative of a feature selected from the group consisting of:
whether said content is complete,
whether said content has been updated within a predetermined period prior to a present time, and
whether said report concerns a business entity that is subordinate to another business entity.

7. A system comprising:
a processor; and
a memory that contains instructions for controlling said processor to perform actions of:
(a) receiving a request to provide a report;
(b) determining whether content of said report meets a threshold level of quality; and
(c) issuing a warning if said content does not meet said threshold level of quality.

8. The system of claim 7, wherein said memory further contains instructions for controlling said processor to perform actions of:
receiving a communication that confirms that said request should be fulfilled; and
dispatching said report, in response to said communication.

9. The system of claim 7, wherein said quality is indicative of whether said content is complete.

10. The system of claim 7, wherein said quality is indicative of whether said content has been updated within a predetermined period prior to a present time.

11. The system of claim 7, wherein said quality is indicative of whether said report concerns an entity that is subordinate to another entity.

12. The system of claim 7, wherein said memory further contains instructions for controlling said processor to perform actions of:
receiving a communication that confirms that said request should be fulfilled; and
dispatching said report, in response to said communication, wherein said quality is indicative of a feature selected from the group consisting of:
whether said content is complete,
whether said content has been updated within a predetermined period prior to a present time, and
whether said report concerns a business entity that is subordinate to another business entity.

13. A storage medium comprising a program encoded thereon that is executable in a processor to cause said processor to perform a method that includes:
receiving a request to provide a report;
determining whether content of said report meets a threshold level of quality; and
issuing a warning if said content does not meet said threshold level of quality.

14. The storage medium of claim 13, wherein said method further includes:
receiving a communication that confirms that said request should be fulfilled; and
dispatching said report, in response to said communication.

15. The storage medium of claim 13, wherein said quality is indicative of whether said content is complete.

16. The storage medium of claim 13, wherein said quality is indicative of whether said content has been updated within a predetermined period prior to a present time.

17. The storage medium of claim 13, wherein said quality is indicative of whether said report concerns an entity that is subordinate to another entity.

18. The storage medium of claim 13, wherein said method further includes:
receiving a communication that confirms that said request should be fulfilled; and
dispatching said report, in response to said communication,
wherein said quality is indicative of a feature selected from the group consisting of:
whether said content is complete,
whether said content has been updated within a predetermined period prior to a present time, and
whether said report concerns a business entity that is subordinate to another business entity.
